(19) United States
(12) Patent Application Publication
(10) Pub. No.: US 2012/0318707 A1
(43) Pub. Date: Dec. 20, 2012

(54) STACKABLE GRIPS FOR HAND-HELD WRITING AND DRAWING TOOLS

(75) Inventors: Jaqueline K. Zivitz, Plymouth Meeting, PA (US); Danielle Nurick, Plymouth Meeting, PA (US)

(73) Assignee: DJ DISCOUNTS, LLC, Plymouth Meeting, PA (US)

(21) Appl. No.: 13/526,404

(22) Filed: Jun. 18, 2012

Related U.S. Application Data
(60) Provisional application No. 61/520,885, filed on Jun. 16, 2011.

(51) Int. Cl. B43K 31/00; B43K 23/008

(52) U.S. Cl. 206/575; 401/6

(57) ABSTRACT

Provided are stackable grips for writing or drawing utensils. The stackable grips comprise an axial hole that allows the grips to slid onto and removably retained on the handle of a writing or drawing tool, and generally comprise ornamentation on an outer portion. By combining multiple stackable grips on a single writing or drawing tool, the tool can be personalized. Also provided are kits comprising a plurality of stackable grips, as well as methods of personalizing a writing or drawing tool.

### CROSS-REFERENCE TO RELATED APPLICATIONS

This claims benefit of U.S. Provisional Patent Application No. 61/520,885 filed Jun. 16, 2010, the entirety of which is incorporated herein by reference.

### BACKGROUND

1. Field of the Invention

This relates generally to apparatus for improving the grip of hand-held writing and/or drawing utensils, and for personalization thereof, and more particularly to stackable and/or interlocking grips for use therewith.

2. Description of Related Art

The use of writing instruments and similar implements (including crayons, markers, pencils, pens, paint brushes and the like) is a skill that productive adults use without thinking about consciously. However, it is generally a skill that requires years to fully develop. Beginning as very young children, proper techniques for holding and/or grasping such instruments must be practiced and gradually such skills become an area of unconscious competence.

Learning the proper grip can be difficult. The correct combination of strength and relaxation is complex, and the smooth surfaces of many writing or drawing tools adds to the challenge. Too tight a grip prevents fluid movement, while too loose a grip does not allow adequate control. During practice, the required grip can be tiring as the required muscles are not fully developed and child's fingers/hands are particularly not adapted to holding writing utensils for extended periods. In addition, in some cases holding writing implements can be physically painful to the gripping hand and/or fingers when practiced repeatedly.

To facilitate proper/more secure gripping, improve ergonomic gripping, allow relaxation, reduce fatigue, and/or to cushion the hand and fingers of children or adults, various devices to assist with gripping pens or pencils have been developed going back at least the last 100 years or more.

In more recent years, auxiliary grips made of material softer than the writing implement itself are widely used, especially by school children. Such grips cover at least the portion of the writing utensil that is to be gripped and are frequently padded or cushioned and are made of foam, rubber, natural materials and/or various plastics.

Another solution is to manufacture a cushioned portion integral with the body of the writing implement, e.g. molded within the body. This approach has been used particularly with pens since they are frequently manufactured with molded plastic bodies/shafts. Unfortunately, this solution is not available for the most common writing utensils used by children, in particular pencils, crayons, and markers. Moreover, most pens still are not manufactured with integral grip cushions, and it is unlikely that will change since many adults prefer pens without a cushioned shaft.

There is therefore a need for solutions to provide the required cushioning, anti-fatiguing, and improved gripping, as well to appeal to children to encourage the use of writing and drawing utensils, make practice fun, and allow personalization of writing, drawing, and other hand-held utensils.

### SUMMARY

Stackable grips for a writing or drawing utensil are provided herein. The grips are also adapted for use with other household hand-held items such as eating utensils, toothbrushes, hairbrushes, and the like. The individual grips are designed to be stacked, or used in combinations, and can be personalized and stacked in a many different orders to allow further customization and personalization of the items on which they are used. They may also be decorated, collected, and traded, particularly among school children, creating a fun aspect to working with writing and drawing utensils.

The grips comprise a body having a first end and an opposing second end with an axis therebetween. An axial hole is defined by a internal surface of the grip body and passes from end to end of the grip. The hole is of sufficient diameter to allow the grip body to be readily slid onto the handle portion of a writing or drawing utensil. The grip is removably retained on the utensil during use of the writing or drawing utensil for example by frictional forces related to the tightness of fit and the surface properties of the internal surface that defines the axial hole. In the direction perpendicular to the axial hole, the grip body has an overall dimension that permits a user to grip the writing or drawing utensil during normal use. The stackable grip further comprises an outer portion covering the body—the outer surface may be integral with the body or may be a covering. A plurality of such stackable grips may be placed adjacent to each other on the handle of the writing or drawing utensil. The outer portion of the stackable grips is adapted for gripping the writing or drawing utensil when a plurality of stackable grips are placed adjacent to each other on the handle of the writing or drawing utensil.

Also provided herein are kits of components comprising a plurality of stackable grips as described herein, in addition to one or more writing or drawing utensils; and one or more supplies for decorating the outer portion of the grips. The kits optionally include one or more of the following: instructions for using the kit components for decorating the grips and personalizing a writing or drawing utensil with the grips; a case or box suitable for storing the components; and access to an informational website providing information relating to one or more of general information on writing or drawing, proper gripping of a writing or drawing utensil, decorating the stackable grips, using the stackable grips, personalizing a writing or drawing utensil, or other activities for children; or any combination of the foregoing.

Provided as well are methods for providing personalization of a writing or drawing utensil using stackable grips. The methods generally comprise the following steps:
a) providing a plurality of stackable grips for writing or drawing utensils, each such grip comprising a body having a first end and an opposing second end with an axis therebetween and having an axial hole passing therethrough, said hole of a bore sufficient to allow the body to be slid onto and removably retained on the handle portion of a writing or drawing utensil during use of the writing or drawing utensil, and an outer portion covering the body; wherein a plurality of such stackable grips may be placed adjacent to each other on the handle of the writing or drawing utensil and wherein the outer portion is adapted for gripping the writing or drawing utensil when a plurality of stackable grips are placed adjacent to each other on the handle of the writing or drawing utensil, and the body has an overall dimension in the direction perpendicular to the axial hole that permits a user to grip the writing or drawing utensil during normal use;
b) providing instructions and one or more supplies for optionally decorating or embellishing the stackable grips according to the person's own preferences; and
c) providing instructions for adding a plurality of stackable to a writing or drawing utensil in an individualized manner.

Such methods therefor allow personalization of the writing or drawing utensil.

These and/or further aspects, features, and advantages of the present invention will become apparent to those skilled in the art in view of this disclosure.

### BRIEF DESCRIPTION OF THE DRAWINGS

FIG. 1 shows an embodiment of a individual stackable grip as described herein.

FIG. 2. depicts an embodiment with a plurality of stackable grips stacked together and arranged along the long axis of a writing implement, e.g. a pencil as shown. Stackable grips or two-different sizes are depicted, but any number of sizes and styles can be combined. In the embodiment shown, the grips contain ornamentation which may be manufactured as part of the grip or surface treatment (such as paint), or the may be decorated by the end-user.

### DETAILED DESCRIPTION

Provided herein are stackable grips for use with writing and drawing implements, as well as other household hand-held items such as eating utensils, toothbrushes, hairbrushes, and the like. The grips are useful for helping to cushion the grip, help improve the ergonomics of repeated or prolonged gripping, and to personalize the writing or drawing utensil or other items. They are particularly fun for children and may be collected or traded. The grips come with pre-decorated and/or can be decorated by the user.

### DEFINITIONS & ABBREVIATIONS

Unless expressly defined otherwise, all technical and scientific terms, terms of art, and acronyms used herein have the meanings commonly understood by one of ordinary skill in the art in the field(s) of the invention, or in the field(s) where the term is used. In accordance with this description, the following abbreviations and definitions apply.

As used herein, the singular form of a word includes the plural, and vice versa, unless the context clearly dictates otherwise. Thus, the references “a”, “an”, and “the” are generally inclusive of the plurals of the respective terms. For example, reference to “a cushioned grip” or “a writing implement” includes a plurality of such “grips” or “implements.”

The words “comprise”, “comprises”, and “comprising” are to be interpreted inclusively rather than exclusively. Likewise the terms “include”, “including” and “or” should all be construed to be inclusive, unless such a construction is clearly prohibited from the context. Further, forms of the terms “comprising” or “including” are intended to include embodiments encompassed by the phrases “consisting essentially of” and “consisting of”. Similarly, the phrase “consisting essentially of” is intended to include embodiments encompassed by the phrase “consisting of”.

Where used herein, ranges are provided in shorthand, so as to avoid having to list and describe each and every value within the range. Any appropriate value within the range can be selected, where appropriate, as the upper value, lower value, or the terminus of the range.

The methods and devices and/or other advances disclosed here are not limited to particular methodology, protocols, and/or structures described herein because, as the skilled artisan will appreciate, they may vary. Further, the terminology used herein is for the purpose of describing particular embodiments only, and is not intended to, and does not, limit the scope of that which is disclosed or claimed.

Although any devices, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent permitted under applicable law. Any discussion of those references is intended merely to summarize the assertions made therein. No admission is made that any such patents, patent applications, publications or references are prior art, or that any portion thereof is either relevant or material to the patentability of what is claimed herein. Applicant specifically reserves the right to challenge the accuracy and pertinence of any assertion that such patents, patent applications, publications, and other references are prior art, or are relevant, and/or material.

As used herein “writing or drawing utensils” include pencils of all types (e.g. graphite pencils, colored pencils, charcoal pencils, grease pencils, wax pencils, eraser pencils, and the like), pens, crayons, markers of all types (felt tip markers, erasable markers, permanent markers) and well as paint brushes, and hand-held artist tools and/or drawing implements.

As used herein “utensils” “implements” “instruments” “devices” and “tools” are synonymous, particularly with respect to writing and drawing. Because the grips are also perfectly suited for use with other hand-held items such as eating utensils, toothbrushes, hairbrushes and the like, the terms can equally apply to any handheld item including all of the foregoing. Moreover, while the description below is primarily made with respect to writing and drawing implements, the skilled artisan will appreciate the discussion and description are equally applicable to the other hand-held utensils, implements, instruments, devices, and tools.

As used herein “interlocking” and “inter-engaging” are substantially the same and indicate that a stack of grips are rotationally connected such that independent rotation around the axial hole of each stackable grip is substantially restricted or not possible. The skilled artisan will appreciate that the rotation of an entire stack of interlocked grips is not impacted directly by the mere fact of interlocking of adjacent stackable grips, but is instead dictated by frictional forces between the stackable grips and the handle of writing tool on which they are located.

As used herein “removably retained” means that a stackable grip is retained on a hand-held tool or utensil onto which it is placed, by for example frictional forces. Under normal circumstance the grip will not inadvertently slip off. However, the grip can be readily removed by sliding the grip along the long axis of the hand-held utensil (e.g. a pencil) for the purpose of removing, replacing, or changing the order of grips in a stack.

### DETAILED DESCRIPTION OF ILLUSTRATIVE EMBODIMENTS

In a first of several aspects, provided herein are stackable grips for a writing or drawing utensil comprising a body having a first end and an opposing second end with an axis therebetween. An axial hole passing therethrough is defined by an inner surface of the grip body. The bore of the hole is sufficient to allow the body to be easily slid onto the handle portion of a writing or drawing utensil, where it is removably retained during use of the writing or drawing utensil. The stackable grips further comprise an outer portion covering the body. A plurality of such stackable grips may be placed adjacent to each other on the handle of the writing or drawing utensil to facilitate gripping of the writing implement and/or to personalize it. The outer portion is adapted for gripping the writing or drawing utensil when a plurality of stackable grips are placed adjacent to each other on the handle. The body has an overall dimension in the direction perpendicular to the axial hole that permits a user to grip the writing or drawing utensil during normal use.

The body may be made of any natural or synthetic material suited for the intended purpose. Presently preferred are rubber or rubberized materials, silicone, open or closed cell foams, plastics or polymers of any suitable type, fabric, elastic, vinyl, or the like. Additionally, in certain embodiments the outer portion can be integral with the grip body or may be a different material that serves as a covering or outer surface. The skilled artisan will appreciate that myriad of combinations are possible for grip body and outer surface. For example, in one embodiment the grip body comprises a foam material and the outer covering comprises fabric, such as terry cloth. Presently preferred fabrics include brightly colored fabrics, interestingly patterned fabrics, and fabrics with interesting textures. Such fabrics are useful herein and may make the stackable grips more appealing to a particular group of users, or may make the stackable grips more comfortable than otherwise. Fabrics may also be used to cover a cushioned or padded grip, and may also be used for their absorptive properties (e.g. terry cloth).

In one embodiment, the outer portion of the grip has a hardness less than the hardness of the handle portion of the writing or drawing utensil, or the grip is cushioned or padded. The skilled artisan will appreciate that by having a lower hardness (as measured, e.g., by any standardized hardness scale) the outer portion can make the grip far more comfortable, especially for children who are learning to grip the implements or for people who must hold the writing tools for an extended time (e.g. during testing for college or professional students).

The body can be of any shape, for example, geometrical shapes such as squares, spheres, discs, cones, pyramids, diamonds, ovals, regular or irregular polygons of any type, and random shapes. In one embodiment they may be shaped like an animal or the head/face of animal such as a kitten, puppy, bunny, lion, hippo, monkey, owl, or the like. In another embodiment, the stackable grips are shaped as rings and/or bands. Band-shaped grips generally feature a substantially flat inner and outer surface. Ring-shaped grips may have any cross-sectional profile. In some embodiments the stackable grips may be reversible, i.e., the inner surface and the outer portion can be exchanged, for example by twisting the grip “inside out.” Grips with ring or band shapes may be more amendable to reversibility. Grips of different shapes or types (e.g. band-shaped and ring shaped) can readily be intermixed along a single hand-held-utensil.

The stackable grips may be of any color or combination of colors. Such color may be integral through-out the grip body and the outer portion, or may be merely a surface treatment on the outer portion. Patterns of color such as stripes, dots, twists, tie-die patterns, are also contemplated for use herein. The grips may also include such features as fluorescent and luminescent (e.g. glow-in-the-dark) color. In certain embodiments the stackable grips also contain ornamentation, such as patterns, textures, figures (including e.g. depictions (fictional or otherwise) of people, animals, flowers, jewels, nature, etc.), symbols, letters, dates, numbers, and the like. In some embodiments ornamentation includes names, sayings, phrases, drawings, likenesses, cartoon characters, logos, and the like.

In one embodiment the grips may have ornamentation indicative of support for or affiliation with a cause or organization, such as the name, colors or a logo or other indicia thereof. The cause or organization may be of any type, for example, a school, college, university, team, society, club, church, civic or charitable organization, or the like. In another embodiment the ornamentation relates to a particular event, season, holiday, or the like. In various embodiments of the grips, the ornamentation is molded, embossed, impressed, embedded, printed, or painted thereon, or any combination thereof. As with the colors, the ornamentation may be separately colored or patterned, and the ornamentation may be separately fluorescent and/or luminescent.

In another embodiment, the ornamentation may comprise simulated gems or jewels, which may be embedded in the grip, or the ornamentation may comprise glitter, sparkles, or other light reflecting and/or refracting substances.

Reversible grips such as those described above may include different ornamentation on the inside surface and the outside surface, or may be differently colored inside and out so that when reversed, the grip appears different to the user and others.

In yet another embodiment, the grips may comprise ornamentation with a partial figure or picture such that only when a predetermined/required number of grips are stacked or placed adjacent to each other, in the proper order will the figure or picture become evident. Such “hidden” pictures can increase the enjoyment factor of using the grips. In preferred embodiments, the number of required stackable grips can range from 2 to about 10. In such embodiments, the grips may also contain a number or code to facilitate the proper ordering of the picture. Additionally, portions of the pictures in some embodiments can be mixed and matched. For example, the head of one figure might be replaced with that of another while the bodies remain unchanged. In one embodiment the pictures are animals and the body of, e.g., a giraffe can be aligned with the head of e.g. a bear, or the like.

The dimensions of the stackable grips may vary according to requirements, e.g. the size or effective diameter of the handle of a particular writing or drawing tool may dictate the optimal diameter of the inner bore of the grip. The length of the grip body along the axis having the axial hole may conveniently be limited to allow a plurality of grips to be placed on the long axis of the writing or drawing tool. In one embodiment the body is less than about one-third of an inch in length along the axis having the axial hole. In other embodiments, it is between about a third of an inch to about a quarter of an inch. The thickness of the wall between the inner surface and the outer portion is generally less than about one half of an inch, but it certain embodiments can range from about one sixteenth of an inch to about one-quarter of an inch. Band shaped stackable grips may be fairly flat, and may tend to have thinner walls. Other geometric shapes will generally be larger overall. In various embodiments, grips with overall widths of about one-half inch to one inch (i.e. the width in the direction perpendicular to the axial hole) are useful herein.

The stackable grips in certain embodiments further comprise interlocking or inter-engaging means that permitting a grip to be inter-engaged with an adjacent stackable grip on the writing or drawing utensil. In one embodiment the inter-engageable means comprise inter-engaging or complementary male and female parts on opposing first and second ends of the grip. In other embodiments the interlocking parts are finger-like or tooth like and can inter-engage for example like the teeth of a set of gears. Such complementary parts can be of any relative shape that allows inter-engagement with an adjacent grip however, it is contemplated herein that the inter-engagement will restrict, minimize, or even prevent independent rotation about the axial holes of adjacent (or stacked) grips. To the extent the there is any rotation of an entire stack of grips, caused for example by repeated gripping and use of the writing/drawing implement, the entire stack of grips will rotate together. This provides the benefit of preserving an interesting or desired pattern of grips established by the user.

In one embodiment the inter-engaging means are integral with the body of the grip, in other embodiments the inter-engaging means are attached to the opposing ends of the stackable grips.

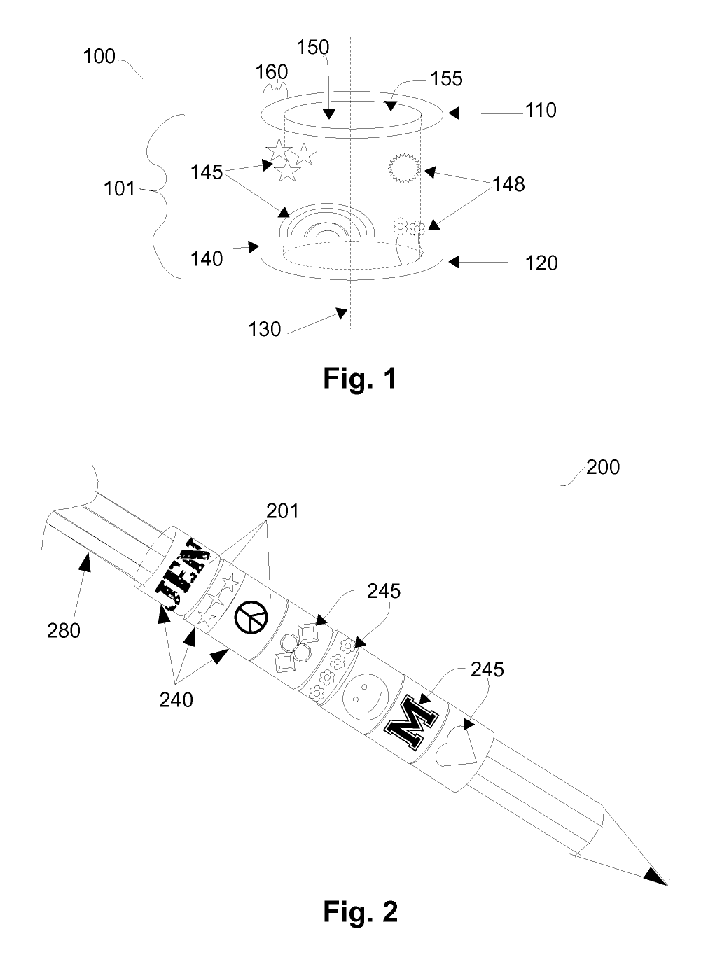

Certain aspects of the invention can be further understood through reference to the drawings. FIG. 1 shows a stackable grip 100. The stackable grip features a body 101 having opposing ends 110, 120 which have longitudinal axis 130 passing therethrough. The body has outer portion 140, which can feature a covering (not shown) such as a fabric covering (e.g. terry cloth, or other textured) and may also provide ornamentations 145. Decorations 148 may be added by the end-user. An axial hole 150 is defined by inner surface 155. A body wall 160 is defined by the space between the outer portion 140 and the inner surface 155. The grip's body 101 can be conveniently slid onto the long axis of a writing or drawing utensil (not shown) by aligning the axial hole 150 therewith and sliding the stackable grip along the length of the writing or drawing utensil.

The stackable grip 100 is retained in place on the writing or drawing utensil, preferably by a frictional fit between the inner surface 155 of the stackable grip and will not slide off, however, the grip can be readily removed by reversing the process of sliding it on the writing or drawing utensil.

With further reference to the Figures, FIG. 2 depicts an embodiment of stackable grippers 200 showing a stack of adjacent grippers 201 personalizing a writing utensil 280. Each gripper 201 depicted contains ornamentation 245 on the outer portion 240. Such ornamentation is not required. The axial holes cannot be seen in the figure because the grippers 201 are removably retained in writing utensil 280. Collectively the stack of grippers 201 are arranged in a unique way that completely personalizes the standard/plain pencil 280.

The stackable grippers are intended to provide the functional aspects of a grip protector or cushion, but they are also intended to allow for personalization of the utensil with which they are to be used. When used actively, they provide a fun activity during decorating, allow for complete personalization of the tools they are placed on, and can be exciting especially for children as a way of expressing their individual tastes and preferences. Some children may also enjoy collecting and/or trading the stackable grippers. In addition, some children may enjoy changing their personalized utensils from time to time to create other unique patterns or ‘displays.’

In another aspect of the invention, kits are provided. The kits can be useful to help accomplish some of the foregoing aspects, by allowing children to acquire a number of stackable grippers at a time, thereby allowing more options for decorating, and personalizing their own grips ad utensils. Generally the kits comprise components including:
a) a plurality of stackable grips for writing or drawing utensils, each such grip comprising a body having a first end and an opposing second end with an axis therebetween and having an axial hole passing therethrough, said hole of a bore sufficient to allow the body to be slid onto and removably retained on the handle portion of a writing or drawing utensil during use of the writing or drawing utensil, and an outer portion covering the body; wherein a plurality of such stackable grips may be placed adjacent to each other on the handle of the writing or drawing utensil and wherein the outer portion is adapted for gripping the writing or drawing utensil when a plurality of stackable grips are placed adjacent to each other on the handle of the writing or drawing utensil, and the body has an overall dimension in the direction perpendicular to the axial hole that permits a user to grip the writing or drawing utensil during normal use;
b) one or more writing or drawing utensils;
c) one or more supplies for decorating the outer portion of the grips;
d) optionally, instructions for using the kit for decorating the grips and personalizing one or more writing or drawing utensils with the grips;
e) optionally, a case suitable for storing and/or displaying the components; and
f) optionally, access to an informational website providing information related to one or more of general information on writing or drawing, proper gripping of a writing or drawing utensil, decorating the stackable grips, using the stackable grips, personalizing a writing or drawing utensil, or other activities for children.

In various embodiments the one or more writing or drawing utensils comprise pencils, pens, crayons, markers, or paint brushes or the like.

The supplies for decorating the outer portion of the grips include any decorating or art supplies. In one embodiment, the supplies include self-adhesive stickers, glue, glitter, sparkles, stones or simulated stones (e.g. rhinestones, colored stones, simulated jewels, gems, or gemstones, crystals, and the like), paint, fabric, markers, pens, brushes, stencils or any combination thereof.

The instructions may be provided on paper, CD-ROM, DVD, USB ‘thumb drive’ or other removable storage device or the like. The kits may further comprise software, drivers, or the like packaged with the hardware, or made available for download. The kits may include the grips and other components together in separate packages or packaged together in a single package. The kits may also include useful or entertaining media files, for example, detailed instructional videos on how to personalize the writing implements or how to decorate the stackable grips. In various embodiments, he instructions for using the kit are provided in written form in a hard copy, in written form digitally, in video or audio form online or via an electronic medium.

Preferably access to the informational website is provided via a uniform resource locator (URL), a hyperlink in an electronic file, or a quick response (QR) code.

In another of the several aspects of the invention, disclosed herein are methods for providing personalization of a writing or drawing utensil using stackable grips. The methods generally comprise the following steps:
a) providing a plurality of stackable grips for writing or drawing utensils, each such grip comprising a body having a first end and an opposing second end with an axis therebetween and having an axial hole passing therethrough, said hole of a bore sufficient to allow the body to be slid onto and removably retained on the handle portion of a writing or drawing utensil during use of the writing or drawing utensil, and an outer portion covering the body; wherein a plurality of such stackable grips may be placed adjacent to each other on the handle of the writing or drawing utensil and wherein the outer portion is adapted for gripping the writing or drawing utensil when a plurality of stackable grips are placed adjacent to each other on the handle of the writing or drawing utensil, and the body has an overall dimension in the direction perpendicular to the axial hole that permits a user to grip the writing or drawing utensil during normal use;
b) providing instructions and one or more supplies for optionally decorating or embellishing the stackable grips according to the person's own preferences; and
c) providing instructions for adding a plurality of stackable to a writing or drawing utensil in an individualized manner;
thereby allowing personalization of the writing or drawing utensil.

As with the kits above, the instructions for use with the methods here may be provided in writing, or via digital medium such as CD-ROM, DVD, USB ‘thumb drive’ or other removable storage device. The instructions may also be provided online for digital download in any file format.

The personalization of a writing tool preferably results in at least three (3) stackable grips being placed adjacent to each other on the writing or drawing utensil. Optionally, the stackable grips may be interlocking grips as described above.

The scope of the invention is set forth in the claims appended hereto, subject, for example, to the limits of language. Although specific terms are employed to describe the invention, those terms are used in a generic and descriptive sense and not for purposes of limitation. Moreover, while certain presently preferred embodiments of the claimed invention have been described herein, those skilled in the art will appreciate that such embodiments are provided by way of example only. In view of the teachings provided herein, certain variations, modifications, and substitutions will occur to those skilled in the art. It is therefore to be understood that the invention may be practiced otherwise than as specifically described, and such ways of practicing the invention are either within the scope of the claims, or equivalent to that which is claimed, and do not depart from the scope and spirit of the invention as claimed.

What is claimed is:

1. A stackable grip for a writing or drawing utensil comprising a body having a first end and an opposing second end with an axis therebetween and having an axial hole passing therethrough, said hole of a bore sufficient to allow the body to be slid onto and removably retained on the handle portion of a writing or drawing utensil during use of the writing or drawing utensil, and further comprising an outer portion covering the body; wherein a plurality of such stackable grips may be placed adjacent to each other on the handle of the writing or drawing utensil and wherein the outer portion is adapted for gripping the writing or drawing utensil when a plurality of stackable grips are placed adjacent to each other on the handle of the writing or drawing utensil, and the body has an overall dimension in the direction perpendicular to the axial hole that permits a user to grip the writing or drawing utensil during normal use.

2. The stackable grip of claim 1 wherein the outer portion is integral with the body.

3. The stackable grip of claim 1 wherein the outer portion has a hardness less than the hardness of the handle portion of the writing or drawing utensil, or the grip is cushioned or padded.

4. The stackable grip of claim 1 wherein the body is of any geometrical shape.

5. The stackable grip of claim 4 wherein the body is a ring or a band, wherein the band features a substantially flat inner and outer surface, and wherein the ring may have any cross-sectional profile.

6. The stackable grip of claim 1 wherein the outer portion contains ornamentation that is molded, embossed, impressed, embedded, printed, or painted thereon.

7. The stackable grip of claim 1 wherein the body is less than about one-third of an inch in length along the axis having the axial hole.

8. The stackable grip of claim 1 which further comprises inter-engaging means permitting the grip to be inter-engaged with an adjacent stackable grip on the writing or drawing utensil.

9. The stackable grip of claim 8 wherein the inter-engageable means comprise inter-engaging male and female parts on opposing first and second ends of the grip.

10. The stackable grip of claim 9 wherein the inter-engaging means are integral with the body of the grip.

11. A kit comprising the following components together in a single package or in separate containers in a bundled package:
a) a plurality of stackable grips for writing or drawing utensils, each such grip comprising a body having a first end and an opposing second end with an axis therebetween and having an axial hole passing therethrough, said hole of a bore sufficient to allow the body to be slid onto and removably retained on the handle portion of a writing or drawing utensil during use of the writing or drawing utensil, and an outer portion covering the body; wherein a plurality of such stackable grips may be placed adjacent to each other on the handle of the writing or drawing utensil and wherein the outer portion is adapted for gripping the writing or drawing utensil when a plurality of stackable grips are placed adjacent to each other on the handle of the writing or drawing utensil, and the body has an overall dimension in the direction perpendicular to the axial hole that permits a user to grip the writing or drawing utensil during normal use;
b) one or more writing or drawing utensils;
c) one or more supplies for decorating the outer portion of the grips;
d) optionally, instructions for using the kit for decorating the grips and personalizing one or more writing or drawing utensils with the grips;
e) optionally, a case suitable for storing the components; and
f) optionally, access to an informational website providing information related to one or more of general information on writing or drawing, proper gripping of a writing or drawing utensil, decorating the stackable grips, using the stackable grips, personalizing a writing or drawing utensil, or other activities for children.

12. The kit of claim 11 wherein the one or more writing or drawing utensils comprise pencils, pens, crayons, markers, or paint brushes.

13. The kit of claim 11 wherein the one or more supplies for decorating the outer portion of the grips include self-adhesive stickers, glue, glitter, paint, gems, or stencils.

14. The kit of claim 11 wherein the instructions for using the kit are provided in written form in a hard copy, in written form digitally, in video or audio form online or via an electronic medium.

15. The kit of claim 11 wherein access to an informational website is provided via a uniform resource locator (URL), a hyperlink in an electronic file, or a QR code.

16. A method for providing personalization of a writing or drawing utensil using stackable grips comprising the steps of:
a) providing a plurality of stackable grips for writing or drawing utensils, each such grip comprising a body having a first end and an opposing second end with an axis therebetween and having an axial hole passing therethrough, said hole of a bore sufficient to allow the body to be slid onto and removably retained on the handle portion of a writing or drawing utensil during use of the writing or drawing utensil, and an outer portion covering the body; wherein a plurality of such stackable grips may be placed adjacent to each other on the handle of the writing or drawing utensil and wherein the outer portion is adapted for gripping the writing or drawing utensil when a plurality of stackable grips are placed adjacent to each other on the handle of the writing or drawing utensil, and the body has an overall dimension in the direction perpendicular to the axial hole that permits a user to grip the writing or drawing utensil during normal use;
b) providing instructions and one or more supplies for optionally decorating or embellishing the stackable grips according to the person's own preferences; and
c) providing instructions for adding a plurality of stackable to a writing or drawing utensil in an individualized manner;
thereby allowing personalization of the writing or drawing utensil.

17. The method of claim 16 wherein the instructions are provided in writing, or via digital medium.

18. The method of claim 16 wherein the personalization results in at least three (3) stackable grips being placed adjacent to each other on the writing or drawing utensil.

19. The method of claim 18 wherein the stackable grips are interlocking.
